(19) United States
(12) Patent Application Publication
(10) Pub. No.: US 2007/0141240 A1
(43) Pub. Date: Jun. 21, 2007

(54) Mould-stripping method

(76) Inventors: Isabelle Dubois, Avon (FR); Martin Mosquet, Bourgoin-Jallieu (FR); Sandrine Reboussin, Pithiviers (FR)

Correspondence Address: BARNES & THORNBURG LLP, P.O. BOX 2786, CHICAGO, IL, 60690-2786, US

(21) Appl. No.: 10/550,127

(22) PCT Filed: Mar. 18, 2004
(86) PCT No.: PCT/FR04/00667

§ 371 Date: Nov. 28, 2006

(30) Foreign Application Priority Data
Mar. 21, 2003 (FR) 0303503

(51) Int. Cl. B28B 7/38; C04B 35/66; B28B 7/36

(52) U.S. Cl. 427/133; 106/38.7; 106/38.24; 264/338

(57) ABSTRACT

This invention relates to a method for improving the unmoulding of concrete, plaster or clay-based parts, involving the application to the mould of a composition, the water concentration of which is less than 0.2%, comprising an ester of a fatty acid having between 4 and 24 carbon atoms and of a neopentyl polyol containing at least 3 hydroxyl groups.

The present invention relates to a method for improving the mould release of hydraulic materials, in particular concrete, plaster or clay-based materials.

Mould release compositions are known for facilitating the unmoulding of hydraulic materials, such as concrete. The purpose of these agents is to prevent the hardened material from sticking to the mould, thereby also preventing damage to the mould. Moreover, the mould release agents allow the preparation of moulded parts with a smooth surface appearance. A smooth surface appearance, without imperfections, is particularly highly valued for visible prefabricated parts such as architectural parts or parts without specific coverings (paints, coatings, etc.).

Conventional mould release compositions are usually based on compounds of inorganic origin such as petroleum oils. However, the use of such compounds poses a health risk and has drawbacks owing, in particular, to their poor biodegradability.

Patent application DE-A-2 253 497 discloses mould release compositions in the form of oil-in-water emulsions in which the inorganic oil is partially replaced by triglycerides. Nevertheless, the triglycerides may only partially replace the compounds of inorganic origin, owing to their excessively high reactivity and the risk of deactivation of the surface of the prefabricated part.

Patent application EP-A-0 328 158 discloses a mould release composition for concrete containing aliphatic carboxylic acid esters with monohydric or dihydric alcohols, the total number of carbon atoms in the ester being between 8 and 46 and the esters having a melting point of greater than 35° C. These products are environmentally advantageous, but do not produce better results in terms of mould release than the oils of inorganic origin.

Patent application EP-A-0 561 465 discloses a biodegradable mould release composition in the form of an oil-in-water emulsion containing esters of hindered polyhydric alcohols and aliphatic carboxylic acids. Nevertheless, the compositions in emulsion form generally require the introduction of surfactants, which stabilise the emulsion. The presence of surfactants has drawbacks in so far as the surfactants are expensive and they reduce the biodegradable nature of the composition. Furthermore, the compositions in emulsion form are generally problematic in terms of stability during storage.

The aim of the present invention is to propose a method for improving the mould release of concrete, plaster or clay-based parts, involving the application of a mould release composition that is effective and does not have the aforementioned drawbacks.

It has now been found that the application to the mould of a composition without water containing an ester of a fatty acid having at most 18 carbon atoms and of a neopentyl polyol containing at least 3 hydroxyl groups allows this aim to be achieved.

A composition of this type, the water concentration of which is less than 0.2%, and which is therefore non-emulsified, is also known in the technical field as a “whole oil”. It therefore allows problems of stability, which are inherent to a formulation in emulsion, to be overcome.

The fatty acid containing between 4 and 24 carbon atoms is preferably a monocarboxylic acid. Nevertheless, dicarboxylic acid esters may also be present in the composition. Of the monocarboxylic acids, straight-chained or branched, saturated or unsaturated monocarboxylic aliphatic acids are preferred. The acid ester of an unsaturated acid is particularly preferred.

The ester is preferably an acid ester containing between 16 and 20 carbon atoms. It is advantageously a complex acid ester containing between 16 and 18 carbon atoms. These acids, which are also known as “industrial” acids, often contain a mixture of acids, and are therefore inexpensive. Oleic, stearic, palmitic, linoleic or ricinoleic-type acids, for example tall oil fatty acids, are particularly preferred in this regard. The composition contains an ester of an acid, as defined above, and of a neopentyl polyol containing at least three hydroxyl groups. The neopentyl polyol may advantageously be selected from the group comprising trimethylolpropane, ditrimethylolpropane, pentaerythritol, dipentaerythritol, tripentaerythritol, trimethylolbutane and mixtures thereof. These alcohols are characterised by the fact that they do not possess a hydrogen atom in the β position of the hydroxyl groups. This structure provides them with particular stability, in particular with regard to heat.

The ester may be a total ester, in which all of the hydroxyl groups are esterified. However, it may also be a partial ester, having a specific number of free hydroxyl functions. Finally, the composition may also contain complex esters, obtained by successive esterification in the presence of monocarboxylic acids and dicarboxylic acids. However, said complex esters are less desirable because of their high viscosity.

Generally, the mould release composition contains the aforementioned ester in a proportion of between 10 and 100% by weight, preferably between 20 and 60% by weight.

According to one particular embodiment of the invention, the mould release composition contains, in addition to the aforementioned ester, one or more terpene derivatives.

The presence of terpene derivatives in the mould release composition allows the viscosity of the mould release composition to be reduced, thus facilitating spraying thereof, and increases its biodegradability.

Terpenes are a class of hydrocarbon present in plants and isoprene unit compounds. They may, in particular, be terpene alcohols. Of these alcohols, terpineols and the isomers thereof, having the general formula C₁₀H₁₇OH, are preferred. Products of natural origin, such as pine oil, are also advantageous.

The terpene derivative is preferably present in the composition in a proportion between 0 and 90% by weight, in particular from 10 to 70% by weight.

According to another embodiment of the invention, the mould release composition also contains an inorganic component. This inorganic component may be an inorganic solvent and/or an inorganic oil.

Although these components of inorganic origin are not particularly desirable in terms of biodegradability, the use thereof allows, in particular, the formulation of mould release compositions for specific applications requiring a low viscosity, allowing improved spraying, and thus reducing the cost of the mould release composition. The term “solvents or inorganic oils” refers to mixtures of hydrocarbons of inorganic origin or of more or less heavy synthesis containing mainly aromatic, paraffinic and cycloparaffinic hydrocarbons.

The inorganic components may be present in the mould release composition in a proportion of between 0 and 90%. Preferably, when present, they form 10 to 70% by weight.

The above-described mould release compositions may, of course, also contain conventional additives in the material. Examples of these agents include wetting agents, anti-corrosive agents, antioxidant agents, waxes and resins.

A particularly preferred mould release composition according to the invention contains 30 to 90% by weight, preferably 35 to 50% by weight, ester as defined above and 10 to 70% by weight, preferably 50 to 65% by weight, terpene derivative.

A highly particularly preferred mould release composition consists of these two components, without any other supplementary component.

The above-described preparation of the mould release compositions is carried out in a manner known per se. The composition may thus be prepared by simple mixing of the starting materials at ambient temperature until a homogeneous mixture is obtained. The preparation is thus easier than in the case of a mould release composition in emulsion form requiring a step of emulsification in the presence of surface-active agents.

The method improving the mould release of concrete, plaster or clay-based parts according to the invention involves the application to the mould of a composition as described above. This application may be carried out by any means known to a person skilled in the art, for example by spraying or application using a cloth. Application by spraying is a particularly advantageous form of application.

The coverage rate of the mould release composition, which is applied by spraying, is generally from 50 to 100 m²/litre.

The subsequent steps of casting and unmoulding the parts produced using concrete, plaster or clay-based compositions may be carried out in an entirely conventional manner.

The invention will be described below in greater detail with reference to the following non-limiting examples.

### EXAMPLE 1

An ester of tall oil fatty acid pentaerythritol (Resinoline E 500, Dérivés Terpéniques et Résinoléiques, France) was used as a mould release composition.

This product had a viscosity of 175 cSt at 20° C. The measured acid value was 15 mg KOH/g of product.

### EXAMPLE 2

A mould release composition was prepared by mixing 4 kg of resinoline E 500 and 6 kg of a mixture of pine oil and terpene alcohols containing from 88 to 93% by weight terpeneol alcohol (Dertol 90, Dérivés Terpéniques et Résinoléiques, France) at ambient temperature.

The composition thus obtained had a viscosity of 60 cSt at 20° C. Its acid value was 6 mg KOH/g of product.

### EXAMPLE 3

A mould release composition was prepared by diluting 1 kg of the composition from the preceding example with 1 kg of dearomatised white spirit-type solvent (Spirdane D60, Total, France) at ambient temperature.

The composition thus obtained had a viscosity of 6.22 cSt at 20° C. and an acid value of 3.2 mg KOH/g of product.

### EXAMPLE 4

A mould release composition was prepared by mixing 4 kg of tall oil fatty acid pentaerythritol (Resinoline E 500, Dérivés Terpéniques et Résinoléiques, France) with 6 kg of dearomatised white spirit-type solvent (Spirdane D60, Total, France) at ambient temperature.

The composition thus obtained had a viscosity of 7.3 cSt at 20° C. and an acid value of 5 mg KOH/g of product.

### EXAMPLE 5

A mould release composition was prepared by diluting 5 kg of the composition from Example 2 with 5 kg of paraffinic petroleum oil (HMVIP30, Shell, France) at ambient temperature.

The composition thus obtained had a viscosity of 15.6 cSt at 20° C. and an acid value of 3 mg KOH/g of product.

Application Tests

The mould release compositions from Examples 1 to 5 were sprayed on each of the metal walls of a mould having a length of 30 cm, a width of 10 cm and a height of 30 cm.

In the laboratory, the mould release composition was applied in a quantity of approximately 50 m²/litre.

Normal, non-admixed, non-steam-cured concrete according to the specifications provided in Table 1, comprising Saint Pierre La Cour CEM 1 52,5 CPA CE CP2 NF-type cement, was then poured into the mould. The concrete composition thus obtained was poured into the mould then needle-vibrated (2×20 sec).

The concrete part was unmoulded 24 hours after pouring.

The application performance of the mould release compositions was assessed according to the criteria for observing the part and the mould specified in Table 2. Both the appearance of the concrete part and the appearance of the mould were therefore assessed.

A degree of magnitude according to Table 3 is associated with each criterion.

TABLE 1
composition of the concrete used for the application test

| Palvadeau aggregate | 1 M³ (Kg) |
|---|---|
| 12.5 | 376 |
| 8/12.5 | 276 |
| “ 4/8” | 423 |
| “ 2/4” | 57 |
| “¼” | 245 |
| 0.5/1 | 134 |
| 0.315/1 | 198 |
| 0/0.315 | 107 |
| 0/0.160 | 23 |
| CEMENT | 350 |
| WATER | 175 |
| TOTAL | 2364 |

TABLE 2
Application performance

| | Appearance of the | | Appearance of the |
|---|---|---|---|
| Abbreviation | concrete part | Abbreviation | mould |
| P | Facing appearance | Po | Dusting |
| B | Microbubbling | E | Fouling |
| Po | Dusting | Pt Ac | Catching points |

TABLE 3
Criterion - degrees of assessment

| Microbubbles | | |
|---|---|---|
| Dust | | |
| Residues | | |
| Catching points | Degrees of assessment | Facing appearance |
| None | (−−) | Poor |
| Slight | (−) | Average |
| Marked | (+) | Good |
| Very Marked | (++) | Very good |

The test was repeated at least three times in succession in order to evaluate the performance of the mould release composition more effectively. The results of the assessment of the various mould release compositions following the application test are provided in Table 4.

TABLE 4
Results of the application test

| Compositions | Tests | Concrete | Mould |
|---|---|---|---|
| 1 | 4 | P(+) | E(−−) |
| | | B(−) | / |
| | | Po(−) | Po(+) |
| 2 | 5 | P(++) | E(−) |
| | glazed appearance | B(−) | / |
| | | Po(−) | Po(+) |
| 3 | 5 | P(+) | E(−) |
| | | B(−) | / |
| | | Po(−) | Po(−) |
| 4 | 6 | P(+) | E(−) |
| | | B(−) | / |
| | | Po(−−) | Po(−) |
| 5 | 3 | P(+) | E(−−) |
| | | B(−) | PtAc(−−) |
| | | Po(−) | Po(−−) |

By way of comparison, the same tests were carried out with a plurality of commercially available formulations. These were formulations of the products CHRYSODEM CH2, CHRYSODEM EC01, CHRYSODEM BIO 2 and CHRYSODEM B, the compositions and viscosities of which are set out in Table 5.

TABLE 5
Characteristics of the comparison mould release compositions

| | CHRYSODEM | CHRYSODEM | CHRYSODEM | CHRYSO- |
|---|---|---|---|---|
| | CH2 | ECO 1 | BIO 2 | DEM B |
| Type | Pure | Pure | Vegetable | Inorganic |
| of oil | inor- | vegetable | base (colza | emulsion |
| | ganic | (colza oil | oil base) | |
| | | and ester | | |
| | | base) | | |
| Viscos- | 40 cSt | 40 cSt | 8.5 cSt | 5 poises |
| ity @ | | | | |
| 20° C. | | | | |

The results of the tests carried out on the comparison compositions are set out in Table 5.

TABLE 5
Results of the assessment after application tests
of the mould release compositions or comparison

| | Number | Appearance of the | Appearance of the |
|---|---|---|---|
| Reference oils | of tests | concrete part | formwork |
| Chrysodem CH2 | 4 | P(+) | E(−−) |
| | | B(+) | / |
| | | Po(−−) | Po(−) |
| | | P(+) | E(−) |
| Chrysodem ECO 1 | 4 | B(−) | PtAc(−) |
| | | Po(−−) | Po(−) |
| Chrysodem BIO 2 | 4 | P(+) | E(−) |
| | | B(+) | PtAc(−) |
| | | Po(−) | Po(−) |
| Chrysodem B | 4 | P(++) | E(−) |
| | | B(−−) | / |
| | | Po(−−) | Po(+) |

It will be noted that the best facing appearance was obtained with the oil in emulsion Chrysodem B. This oil provided a very attractive facing appearance with little microbubbles. This same facing appearance was obtained with composition 2, with an identical formwork appearance. The two mould release compositions allowed the microbubbles of the parts to be reduced compared to conventional mould release compositions.

It will therefore be noted that the use of the compositions according to Examples 1 to 5 provides results that are at least equivalent to, if not better than, those of conventional mould release compositions.

1. Method for improving the mould release of concrete plaster or clay-based parts, involving the application to the mould of a composition containing less than 0.2% by weight water comprising an ester of a fatty acid having between 4 and 24 carbon atoms and of a neopentyl polyol containing at least three hydroxyl groups.

2. Method according to claim 1, wherein the composition also contains at least one terpene derivative.

3. Method according to claim 2, wherein the terpene derivative is a terpene alcohol.

4. Method according to claim 1, wherein the composition also contains a component of inorganic origin.

5. Method according to claim 1, wherein the neopentyl polyol is selected from trimethylolpropane and pentaerytritol.

6. Method according to claim 1, wherein the ester is an acid ester containing between 16 and 20 carbon atoms.

7. Method according to claim 1, wherein the ester is an unsaturated acid ester.

8. Method according to claim 7, wherein the ester is a tall oil fatty acid ester.

9. Method according to claim 1, wherein the ester is present in the composition in a proportion between 10 and 100% by weight.

10. Method according to claim 9, wherein the ester is present in the composition in a proportion between 20 and 60% by weight.

11. Method according to claim 2, wherein the terpene derivative contains terpineol.

12. Method according to claim 11, wherein the composition contains a plurality of terpineol isomers.

13. Method according to claim 2, wherein the terpene derivative is present in the composition in a proportion between 0 and 90% by weight.

14. Method according to claim 4, wherein the component of inorganic origin is a solvent and/or paraffinic, cycloparaffinic or aromatic oil.

15. Method according to claim 4, wherein the inorganic component is present in the composition in a proportion of between 0 and 90% by weight.

16. Method according to claim 4, wherein the composition contains between 30 and 90% by weight ester and between 70 and 10% by weight terpene derivative.

17. Method according to claim 16, wherein the composition contains between 35 and 50% by weight ester and between 50 and 65% by weight terpene derivative.
